(19) United States
(12) Patent Application Publication
(10) Pub. No.: US 2017/0317452 A1
(43) Pub. Date: Nov. 2, 2017

(54) DEVICE FOR STORING ELECTRICAL CORDS

(71) Applicant: WILLIAM COREY, ELIZABETHTOWN, NC (US)

(72) Inventor: WILLIAM COREY, ELIZABETHTOWN, NC (US)

(21) Appl. No.: 15/140,205

(22) Filed: Apr. 27, 2016

(51) Int. Cl. H01R 13/72; B65H 75/44

(52) U.S. Cl. CPC H01R 13/72; B65H 75/4476

(57) ABSTRACT

A device for storing excess electrical cord length on or near an electrical outlet. The device features one or more protrusions or cleats that extend away from the surface of the outlet cover into a plane that is substantially perpendicular to the plane in which the outlet cover rests. Each protrusion has an attachment portion, a body portion and a flange located at the end or terminus of each protrusion. The flange is shaped to retain electrical cords that are wrapped around the body of the device in that the flange extends away from the terminus of the protrusion into a plane that is substantially parallel to the plane of the outlet cover. Further, the body includes an opening through which a plug can be passed. Alternately, the device could feature two or more protrusions side by side and need not be directly attached to an electrical outlet cover.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### BACKGROUND OF THE INVENTION

### (a) Field of the Invention

The present invention is in the technical field of electrical outlet covers. More particularly, the present invention is in the technical field of apparatuses and methods of storing electrical cords and thereby reducing clutter.

### (b) Background Art

The electrical cord is ubiquitous in modern day homes, schools, offices, and the like. Virtually everywhere one goes there are electrical outlets and a variety of electrical devices featuring cords to plug into the outlets. As anyone with a kitchen or a home entertainment system learns, storing excess electrical cord length such that the cords are out of the way and not visually distracting is a problem countless people attempt or fail to solve on a daily basis.

There are, as expected, a variety of ways in which industrious individuals have attempted to tackle the problem of excess electrical cord length. For example, U.S. Pat. No. 4,149,765 issued to Paul Mortelmans (hereinafter the “'765 patent”) discloses a vacuum cleaner in which the cord and the plug are stored in the handle of the vacuum cleaner. Similarly, there are other devices described in the prior art detailing various forms of retractable electrical cords in which the cord is stored within the electrical device itself. However, in order to use these types of devices, the electrical cords and devices must be specifically configured to have retractable electrical cords. Such is not the case with the vast majority of electrical devices nor would such devices assist a user in storing a standalone electrical extension cord.

Another device disclosed in the prior art is U.S. Pat. No. 7,048,222 issued to Gordon H. Curtiss (hereinafter the “222 patent”). The '222 patent describes a device with two conical cord winding posts attached to a plate meant to fit over a wall-mounted electrical outlet. The '222 patent teaches two cord winding posts projecting outwardly from a face of the plate and a method of using the device in which the user wraps a cord around the two cord winding posts in a figure-eight configuration. More specifically, the device is configured such that the user can use two posts located above and below an area in which the electrical outlet plug itself is located to hold excess electrical cord length combined with a cavity that is below the electrical outlet plug to store additional excess cord length. As a result, this device has several drawbacks; namely, the manner in which it is designed to be used does not adequately store electrical cords without obscuring or interfering with the outlet plug itself, making the device of limited utility. In addition, the cord winding posts do not do an adequate job of retaining electrical cords because the only structure preventing the cords from falling off of the posts is the conical shape of the posts themselves.

In configuring the device to accept cords that are wrapped around both the upper and lower cord winding posts, the '222 patent teaches a device in which the storage of the cords obscures the electrical outlet itself. This has both functional and aesthetic consequences. First, the cords are visibly intersecting the device itself leading to additional visual clutter that may be even less desirable than letting the cords remain free. Second, the cords are stored such they at least partially interfere with the user's ability to further access the outlet, drastically decreasing its utility, especially when one considers most outlets feature more than one plug.

As a result, there is a need for a device that allows a user to store excess electrical cord length on or near an electrical outlet without obstructing the electrical outlet itself such that the amount of visual clutter is reduced.

### BRIEF SUMMARY OF THE INVENTION

The invention disclosed herein is a device that can be used to store electrical cords on or near the surface of an electrical outlet cover. More specifically, the device includes a protrusion associated with an electrical outlet cover around which electrical cords can be wrapped without obstructing access to the outlet.

In discussing the invention further, reference will be made to the inventor's preferred embodiments; however, there are a variety of ways in which the apparatus can be designed to achieve the same purpose. In a preferred embodiment, the device is an electrical outlet cover featuring one or more protrusions or cleats around which electrical cords can be wrapped. In the preferred embodiment and best mode of the invention, the outlet cover features one or more cleats that extend away from the surface of the outlet cover into a plane that is substantially perpendicular to the plane of the face of the outlet cover, i.e., the plane in which the wall is located as most electrical outlet covers will be attached to walls. Further describing the preferred embodiment, the protrusion or cleat has an attachment portion that connects the protrusion or cleat to the electrical outlet cover or other surface, as well as a body portion and a flange. The shape of the flange allows the device to retain excess electrical cord length wrapped around the body portion, i.e., the flange helps to prevent the cords from slipping off of the protrusion. In a preferred embodiment, the flange, being located at the terminus of the protrusion or cleat, extends into a plane that is substantially parallel to the plane of the face of the outlet. Further, the preferred embodiment also includes an opening in the body of the cleat that allows the user to pass the plug of an electrical device through the opening in the cleat and then plug the device into the associated outlet. While the opening need only be large enough to pass a standard sized plug through, in the preferred embodiment, the width of the opening is substantially similar to the width of the aperture through which the electrical outlet can be accessed. Alternately, the device could feature two or more protrusions side-by-side, a configuration allowing the wrapping of two electrical cords about the protrusions of the device such that the protrusions used in tandem, form a cleat.

The shape of the protrusion or cleat helps to visually reduce the clutter associated with having multiple electrical cords lying on a surface such as a kitchen countertop because the cleat protrudes away from the surface of the outlet cover, i.e., towards the user when the user views the device “head on.” Similarly, the shape of the flange also assists in hiding the stored electrical cord length. In a preferred embodiment, the flange is located at the terminus or end of the cleat, i.e., the portion of the cleat or protrusion that is farthest away from the surface of the electrical outlet. The point at which the body and the flange meet is smooth and rounded and the protrusion or cleat as a whole protrudes toward the user thus making it less noticeable when the device is viewed from the front. This feature can be particularly helpful in household situations where reducing visual clutter is a priority.

### BRIEF DESCRIPTION OF THE SEVERAL VIEWS OF THE DRAWINGS

FIG. 1 is a perspective view of a preferred embodiment of the disclosed device;

FIG. 2 is a side view of a preferred embodiment thereof; and

FIG. 3 is a top view of a preferred embodiment thereof.

### DETAILED DESCRIPTION OF THE INVENTION

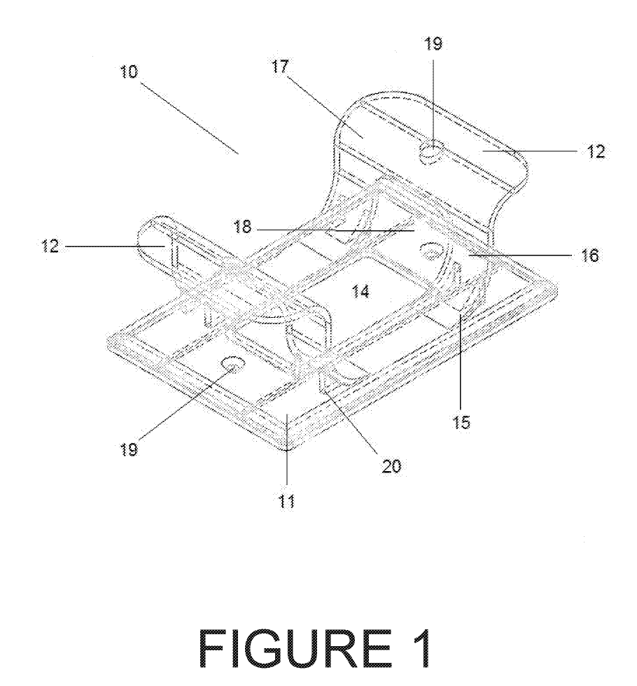

Referring now to the invention in more detail, in FIG. 1 there is shown the preferred embodiment and best mode of the cord storage device described and claimed by this application. FIG. 1 shows the cord storage device, generally 10, attached to an electrical outlet cover 11. In this embodiment, there are two protrusions 12 that flank a generally rectangular aperture 14 in the electrical outlet cover 11 through which an electrical outlet (not shown) can be accessed when the electrical outlet cover 11 is placed over an electrical outlet. In the best mode of this device, the protrusions are cleats 12. Each cleat 12 has an attachment portion 15 at which the cleat 12 is fixed to the electrical outlet cover 11. In addition, each cleat 12 has a body portion 16 that extends outward and away from the electrical outlet cover 11 into a plane roughly perpendicular to the plane of the electrical outlet cover 11. In addition, each cleat 12 features a flange 17 for retaining cords wrapped around the cleat 12. In the preferred embodiment, the flange 17 extends away from the body 16 of the protrusion or cleat 12 into a plane that is substantially parallel to the electrical outlet cover 11. The shape of the body 16 and flange 17 together allow a user to wrap an electrical cord (not shown) around one or both cleats 12. Furthermore, the flange 17 is shaped to prevent such an electrical cord from sliding off of the end(s) of one or both cleats 12. In addition, the body 16 of the cleat 12 features an opening 18 that allows a user to pass the end of an electrical cord featuring a plug (not shown) through the body 16 of the cleat 12.

In more detail, still referring to the invention of FIG. 1, the rounded shape of the cleat 12 in this embodiment is shown in detail. More specifically, the cleats have rounded edges rather than sharp or right angles and are configured to protrude outwards away from the electrical outlet 11 into a plane that is roughly perpendicular with the plane in which the outlet cover 11 rests. In addition, the point of contact between the flange 17 and the body 16 of the cleat or protrusion 12 is rounded. As a result, when someone looks at the electrical outlet cover 11, the cleats extend towards the user and “blend in” visually making their presence on or near the electrical outlet cover 11 harder to see. Thus, excess electrical cord length can be stored in such a way that it is not producing as much “visual clutter.”

Moreover, the device can consist of any number of protrusions or cleats 12 that do not have to be directly in contact with or fixed to the surface of an electrical outlet cover 11. Further, the orientation of the protrusions 12 in FIG. 1 is not meant to be the only orientation available. A skilled artisan would appreciate there can be as few as one protrusion 12 or there can be a plurality of such protrusions or cleats 12 and they need not be located directly above and below the outlet as shown in FIG. 1, but could be located to either side of the outlet and/or do not have to be located on the surface of the outlet cover 11 at all. It is perfectly feasible to create the same device such that it is not integrated into the surface of an electrical outlet cover 11, but can either be attached to an electrical outlet cover 11 or to another surface near the outlet using temporary or permanent fixing means well known in the art.

In further detail, still referring to the invention of FIG. 1, a user makes use of the preferred embodiment of the disclosed device by first fixing the outlet cover 11 to a wall, outlet box, housing or other surface encompassing an electrical outlet (not shown) using standard attachment means including screws or other conventional fasteners. As can be seen in FIG. 1, there are screw holes 19 located both in the outlet cover 11 as well as the flange 17 of the cleat 12. Such a configuration allows a user to screw a fastener into the holes 19 in the outlet cover 11 without having to find a way to negotiate the screwdriver or other tool around the flange 17 of the cleat 12. Next the user passes an electrical cord from an electrical appliance (not shown) or an electrical extension cord (not shown) through the opening 18 in the body 16 of the cleat allowing the user to plug the electrical cord in to the electrical outlet (not shown). At that point, the electrical cord can be passed around one or both of the cleats 12 such that the cord will be held on the protrusion or cleat 12 by the flange 17.

Alternately, the user can wrap an electrical cord (not shown) around more than one protrusion or cleat 12, but doing so might inhibit the user's ability to use an additional protrusion or cleat 12 to retain a second cord. It is possible that each of the protrusions or cleats 12 can be made of more than one protrusion. In other words, the flange need not be a continuous structure that connects each leg 20 of the attachment portion 15. Or to put it another way, there could be two or more protrusions or cleats 12 side by side that work in tandem to function as a single cleat 12. It is also possible to place the protrusions or cleats 12 anywhere on the electrical outlet cover 11, but they do not have to be fixed to the outlet cover 11 at all. It is entirely possible to configure the device as one or more separate protrusions or cleats 12 that can be fixed to or near an electrical outlet cover 11 using convention attachment means well known in the art.

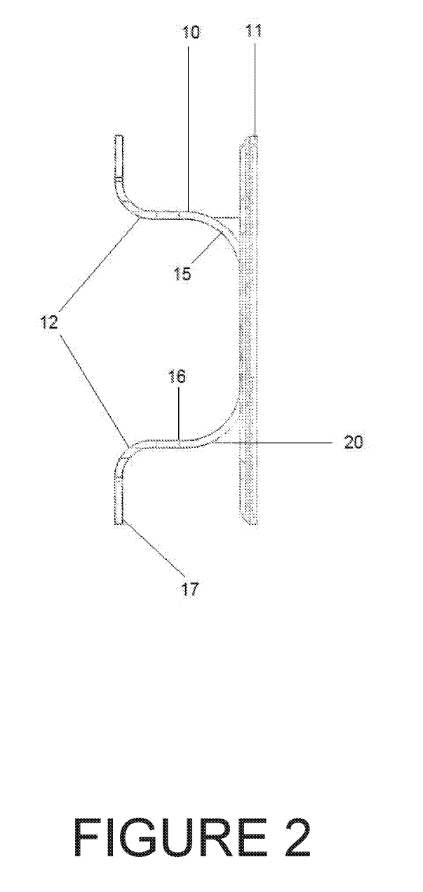

FIG. 2 shows the shape of the protrusions or cleats 12 in the preferred embodiment in side view. As can be seen in FIG. 2, each protrusion or cleat 12 consists of an attachment portion 15, a body portion 16 that extends away from the attachment portion and a flange 17 located at the end or terminus of the protrusion or cleat 12. As shown in FIG. 2, the flange 17 extends away from the body 16 of the cleat 12 into a plane that is substantially parallel to the plane of the outlet cover 11. The shape of the protrusion or cleat 12 allows the protrusion or cleat 12 to be present on the surface of the electrical outlet cover 11 without interfering with the ability of a user to access and use the electrical outlet (not shown) itself. Moreover, the shape of the protrusion or cleat 12 allows it to retain electrical cords more efficiently than other devices by preventing the cords from slipping off the end of the protrusion or cleat 12.

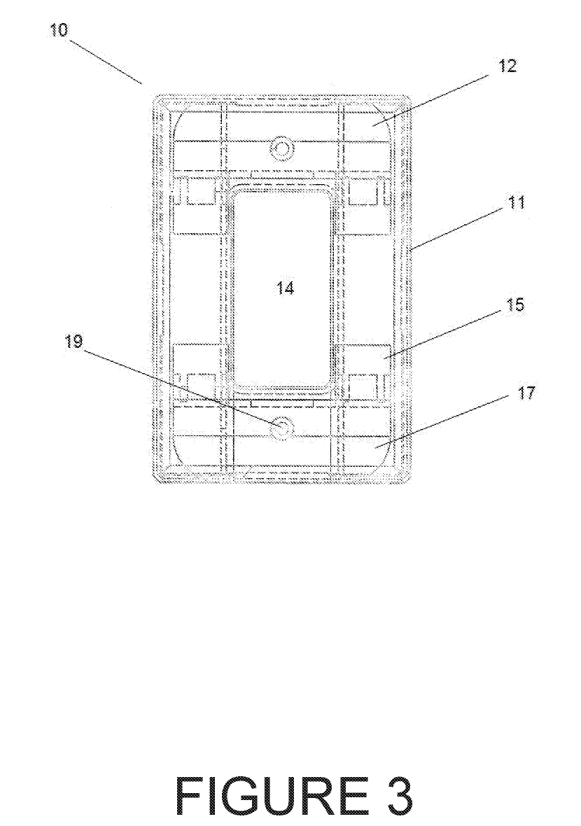

Some of the advantages of using this device are more apparent in FIG. 3. More specifically, FIG. 3 shows the device 10 integrated with an electrical outlet cover 11 as viewed from the front or “head-on”. FIG. 3 shows the outlet cover 11 with protrusion or cleats 12 attached above and below the aperture 14 for the electrical outlet. Each protrusion or cleat 12 has an attachment portion 15 in contact with the electrical outlet cover 11, a body portion 16 and a flange 17. FIG. 3 also shows the screw holes 19 in the flange 17 portion of the protrusion or cleat 12 that make it easier to install the outlet cover 11 over an electrical outlet (not shown). As seen from this angle, the protrusions or cleats 12 “blend in” with the outlet cover 11 making the protrusion or cleats 12 less visually obvious when viewed from the front.

The protrusions or cleats 12 of the device can be constructed of any suitable material being durable and inflexible enough to hold their shape and support the weight of an electrical cord wrapped around the body 16. Typically, the cleats or protrusions 12 will be made of the same or a similar material to the electrical outlet cover 11 to or near which they are attached. Making the protrusions or cleats 12 out of the same material the electrical outlet cover 11 is made of helps to “hide” the protrusions or cleats 12 when they are viewed from the front by a user. In the best mode of the device, the protrusions or cleats 12 rise approximately 1.60 inches off of the surface to which they are attached and are spaced approximately 3.20 inches apart. Furthermore, in the best mode of the device, the attachment portion 15 has two legs 20 that define the aperture 14 in the cleat 12 are spaced approximately 1.30 inches apart.

The advantages of the present invention include, without limitation, the ability of a user to store excess electrical cord length at or near the point at which the cord draws power, i.e., the electrical outlet, such that the storage of the cords is not visually displeasing. In broad terms, the present invention is a unique pair of protrusions for storing excess electrical cord length at or near the source of power comprising a first protrusion and a second protrusion that in tandem form a cleat, the protrusions each shaped both to receive and retain cords wrapped about the protrusions without producing excess visual clutter and while allowing the cord to still be easily plugged into an associated electrical outlet.

Reference throughout the specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout the specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

It is understood that the above described embodiments are only illustrative of the application of the principles of the present invention. The present invention may be embodied in other specific forms without departing from its spirit or essential characteristics. The described embodiment, including the best mode, is to be considered in all respects only as illustrative and not restrictive. The scope of the invention is, therefore, indicated by the appended claims, if any, in conjunction with the foregoing description.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1-11. (canceled)

12: An apparatus for storing cords with an electrical outlet comprising at least one substantially S-shaped protrusion extending away from an outer surface of the electrical outlet into a plane that is substantially perpendicular to an outer surface of the electrical outlet, said protrusion being configured to retain electrical cords.

13: The apparatus of claim 12 wherein the protrusion is an S-shaped cleat.

14: The apparatus of claim 13 wherein the cleat features a flange configured to prevent a cord that is wrapped around the cleat from slipping off the cleat.

15: The apparatus of claim 12 comprising a plurality of substantially S-shaped protrusions each extending into a plane that is substantially perpendicular to the outer surface of the electrical outlet.

16: The apparatus of claim 15 wherein each of the plurality of protrusions has an attachment portion, a flange configured to prevent a cord that is wrapped around the cleat from slipping off the cleat and a body portion; wherein the body portion has an opening.

17: The apparatus of claim 16 wherein the protrusions are cleats.

18: The apparatus of claim 13 wherein the cleat has a body portion with an opening.

19: The apparatus of claim 15 wherein each cleat has a body portion with an opening.

20: An electrical outlet cover comprising:
a face oriented in a first plane, wherein the face of the electrical outlet features a plurality of protrusions extending away from the face of the electrical outlet cover into a second plane that is substantially perpendicular to the first plane;
wherein at least one of the plurality of protrusions comprises a cleat having an attachment portion, a flange configured to prevent a cord that is wrapped around the cleat from slipping off the cleat and a body portion;
wherein the body portion has an opening;
wherein the at least one protrusion comprising a cleat features a substantially S-shaped structure extending away from the outer surface of the electrical outlet into a plane that is substantially perpendicular to the face of the outlet cover.
